(19) United States
(12) Patent Application Publication
(10) Pub. No.: US 2025/0130532 A1
(43) Pub. Date: Apr. 24, 2025

(54) DEVICE CONFIGURED TO VISUALLY TRANSFORM INTERNAL IMAGERY BY CASCADE OF FLOWABLE MEDIA

(71) Applicant: Tarik Torlak, Valley Center, CA (US)

(72) Inventor: Tarik Torlak, Valley Center, CA (US)

(21) Appl. No.: 18/490,372

(22) Filed: Oct. 19, 2023

(51) Int. Cl. G04F 1/06

(52) U.S. Cl. CPC G04F 1/06

(57) ABSTRACT

A watertight and light-permeable housing defines a hollow interior to contain flowable media as any of a variety of fluids, including colored fluids, sand, other granules, gasses and the like, which are operative to visually transform imagery contained within the housing when acted upon by gravity. Namely, one or more internal visual elements are disposed within the hollow interior and arranged to span any width of the hollow interior. The one or more internal visual elements can take any form or shape and be placed in any number or arrangement within the housing as desired. The appearance of any internal visual elements is revealed or transformed within the housing when the flowable media moves within the housing. Housing and visual element materials may be selected to reduce the refraction of light within the visual timer in order to enhance the visual effect.

### GOVERNMENT CONTRACT

Not applicable.

### CROSS-REFERENCE TO RELATED APPLICATIONS

Not applicable.

### Statement Re. Federally Sponsored Research/Development

Not applicable.

### Copyright & Trademark Notices

A portion of the disclosure of this patent document may contain material which is subject to copyright protection. This patent document may show and/or describe matter which is or may become trade dress of the owner. The copyright and trade dress owner has no objection to the facsimile reproduction by any one of the patent document or the patent disclosure, as it appears in the Patent and Trademark Office patent files or records, but otherwise reserves all copyrights and trade dress rights whatsoever.

### TECHNICAL FIELD

The disclosed subject matter relates generally to a device such as an hourglass or visual timer and, more particularly, to such a device having internal design elements revealed or otherwise visually altered as flowable materials move about them.

### BACKGROUND

Hourglasses have provided a visual method of keeping time for centuries. The prototypical hourglass comprises two glass bulbs connected by a slender neck, enclosing a precisely measured amount of sand or other granules that trickle from one chamber to the other. Some examples of such hourglasses appear in U.S. Pat. No. 4,267,588 to Alexander Daniels and D420,603 to Gary Morga. Over time, various shapes and configurations have been developed such that, in addition to its conventional role in measuring time intervals, the hourglass has evolved into an embodiment of artistic innovation and creative expression.

Intricate designs inside the bulbs, achieved through sand artistry, colored fluids, and other creative elements, have turned these into functional works of art. For instance, U.S. Pat. No. 2,644,890 to M. R. Hollihan discloses an amusement device configured as a luminescent and even phosphorescent hourglass for measuring time in a dark room. U.S. Pat. No. 3,240,007 to M. R. Dock et al. teaches an ornamental invertible fluid-filled timer. U.S. Pat. No. 4,228,649 to Gerhart Weiss teaches a transparent timing device which includes floatation liquid and a float of different densities. These and other proposals captivate viewers as their contents move and float about.

In the modern age, the market has embraced customizable hourglasses. Individuals and organizations have been able to personalize hourglasses with configurations that permit insertion photographs and various other decorative enhancements. For instance, U.S. Pat. Pub. No. 2009/0185454 filed by Jeffrey J. Allen et al. teaches a fillable hourglass configured to receive celebratory, commemorative, or even decorative content such as wedding sand, crematory remains, and the like. In addition to personalized contents, stoppers disposed to maintain such contents within the fillable glass component may comprise decorative enhancements. These customized hourglasses bridge the gap between functional timekeeping and creative expression, offering a canvas for individuality and storytelling within the confines of an enduring symbol of time.

Still, although various proposals have been made to improve the appearance and functionality of hourglasses, none of those in existence combine the characteristics of the present invention. Therefore, there remains a need for a device such as a visual timer and/or hourglass that transforms internal imagery.

### SUMMARY

The present disclosure is directed to a device that is configured to reveal or alter images and designs when some flowable medium contained therein moves about an interior of the hourglass. In some embodiments, the device may be a visual timer or hourglass (terms used alternatively throughout this disclosure) comprises a housing defining a hollow and watertight interior, a plurality of visually distinct flowable media contained within the hollow interior, one or more internal visual elements disposed within and spanning the width of some portion of the hollow interior, and means for supporting the visual timer in a vertical position. It should be noted that while some embodiments of the device are conceptualized as a visual timer and/or hourglass, it will not be necessary that such devices precisely or even accurately keep time to practice the invention. In any event, materials comprising the housing, flowable media, and internal visual elements may be selected so that when the visual timer is vertically adjusted and flowable media shifts in response to gravity, the one or more internal visual elements, in some embodiments otherwise visually imperceptible or indistinguishable from some of the flowable media, are visually transformed.

For purposes of summarizing, certain aspects, advantages, and novel features have been described. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested.

The hourglass housing may define any three-dimensional shape as desired or needed, and therefore, the particular shape of the housing will not limit the invention. That is, the housing may be cylindrical, spherical, polyhedral, ellipsoid, irregularly bulbous, or indeed any other shape or style. The housing need not, but may be, symmetrical on any axis to practice the invention.

Likewise, the housing may comprise any at least partially light permeable, translucent, or transparent material as needed or desired. For example only and not limitation, the housing may comprise glass, plexiglass, acrylic, polymethyl methacrylate (PMMA) or another resin, polycarbonate, polylactic acid (PLA), epoxy, or any other at least partially transparent material or combination of at least partially transparent materials suitable to contain flowable media.

Means for supporting the timer in a user-selected vertical position may be integrated along an exterior defined by the housing or otherwise be provided as an element separable from the housing.

Any of the one or more internal visual elements may also be transparent or translucent to varying degrees. In some embodiments, such internal visual elements may comprise, for example only and not limitation, glass, plexiglass, acrylic, epoxy, PMMA, PLA, or any transparent plastics, resins, glue or silicon, or combination of such materials, known to those of ordinary skill in the art. In some embodiments, the material comprising any of the at least one internal visual elements may be the same as the material of the housing. In any event, it is contemplated that the one or more internal visual elements may be visually imperceptible or at least indistinguishable from the housing when viewed from a distance, but appear to transform or materialize as flowable material surrounds or otherwise moves about such one or more internal visual elements.

To that end, in some embodiments, at least some of the flowable media as well as any materials comprising the housing and internal visual element may be selected so as to reduce the refractive index of light transmitted through the housing and internal visual elements.

In some embodiments, the flowable media may comprise, for example only and not limitation, any combination of sand, granules, gas, fluid, oil, water, and colored water. In one exemplary embodiment, the flowable media comprises a combination of fluid, such as transparent water, and sand or some other granular material having a different specific gravity from the fluid, so that the sand or other granular material is able to fall in response to gravity within the fluid at a definite rate, dependent, as one of ordinary skill in the art will recognize, upon the density and viscosity of the fluid. One of ordinary skill in the art will appreciate that it is also possible for the the flowable media to be suspended or otherwise placed within a vacuum sustained by the housing without departing from the invention.

Likewise, it is contemplated that the flowable medium may comprise a plurality of visually distinct fluids, such as two fluids, three fluids, four fluids, or even more, each having a different specific gravity—or relative density—from one another so that each fluid is able to fall in response to gravity at a different definite rate, dependent upon the relative density and viscosity of each fluid in the housing.

In some embodiments, the fluids may be visually distinguished from one another by color. In some embodiments, the fluids, or, more specifically, any sand, granules, gasses, fluids and the like comprising flowable media, may be visually distinguished from one another by relative opacity. The particular manner of visual distinction will not limit the invention.

It is worth noting, and one of ordinary skill in the art will recognize, that the one or more internal visual elements may take any form or shape, be provided in any number or combination, and placed in any manner within the hollow interior of the housing as needed or desired without departing from the invention. That is, it is contemplated that the one or more internal visual elements may comprise letters, words, symbols, icons, logos, shapes, silhouettes, characters, animals, emojis, scenes, images, whether abstract or otherwise, in any combination, in any number, and placed in any manner within the hollow interior of the housing without limitation.

It is contemplated that providing a device configured to transform internal imagery according to the disclosure and claims provided below may provide an engaging visual experience as any internal visual elements transform when the flowable medium shifts.

Thus, it is an object of the invention to provide a combined practical timekeeping device as a captivating decorative piece.

It is another object of the invention is to provide a practical and aesthetically appealing timer that is adaptable to individual preferences, scenarios, and surroundings.

It is still another object of the invention to provide a time keeping device that visually and aesthetically illustrates educational principals of physics and fluid dynamics.

One or more of the above-disclosed embodiments, in addition to certain alternatives, are provided in further detail below with reference to the attached figures. The disclosed subject matter is not, however, limited to any particular embodiment disclosed.

### BRIEF DESCRIPTION OF THE DRAWINGS

FIGS. 1A and 1B show perspective views of alternative embodiments of a device configured to visually transform internal imagery.

FIG. 2 shows an exploded view of one embodiment of the device configured to visually transform internal imagery.

FIG. 3 shows a perspective view of yet another embodiment of the device configured to visually transform internal imagery.

FIG. 4 shows a perspective view of still another embodiment of the device configured to visually transform internal imagery.

FIG. 5 shows a perspective view of another embodiment of the device configured to visually transform internal imagery.

FIGS. 6A and 6B show sequential perspective views of one embodiment of the device configured to visually transform internal imagery in use.

FIG. 7 shows a perspective view of even another embodiment of the device configured to visually transform internal imagery.

FIGS. 8A and 8B show a set of sequential planar views of one embodiment of device configured to visually transform internal imagery in use.

The disclosed embodiments may be better understood by referring to the figures in the attached drawings, as provided below. The attached figures are provided as non-limiting examples for providing an enabling description of the method and system claimed. Attention is called to the fact, however, that the appended drawings illustrate only typical embodiments of this invention and are therefore not to be considered as limiting of its scope. One skilled in the art will understand that the invention may be practiced without some of the details included in order to provide a thorough enabling description of such embodiments. Well-known structures and functions have not been shown or described in detail to avoid unnecessarily obscuring the description of the embodiments.

### DETAILED DESCRIPTION

Having summarized various aspects of the present disclosure, reference will now be made in detail to that which is illustrated in the drawings. While the disclosure will be described in connection with these drawings, there is no intent to limit it to the embodiment or embodiments disclosed herein. Rather, the intent is to cover all alternatives, modifications and equivalents included within the spirit and scope of the disclosure as defined by the appended claims.

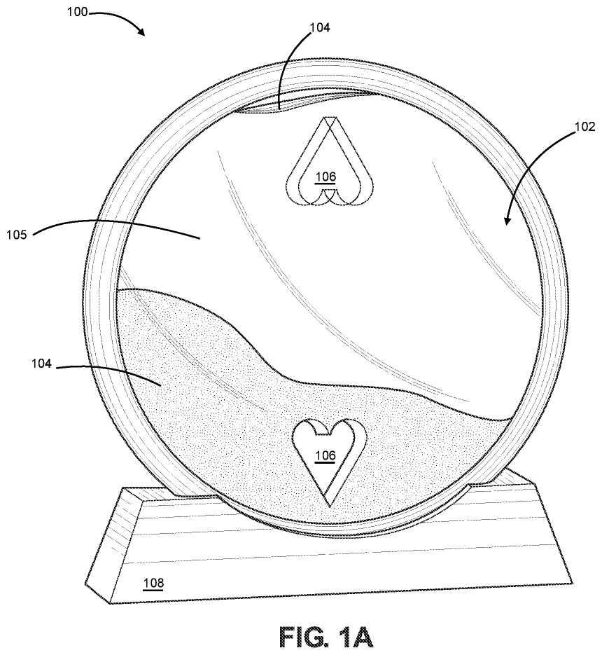

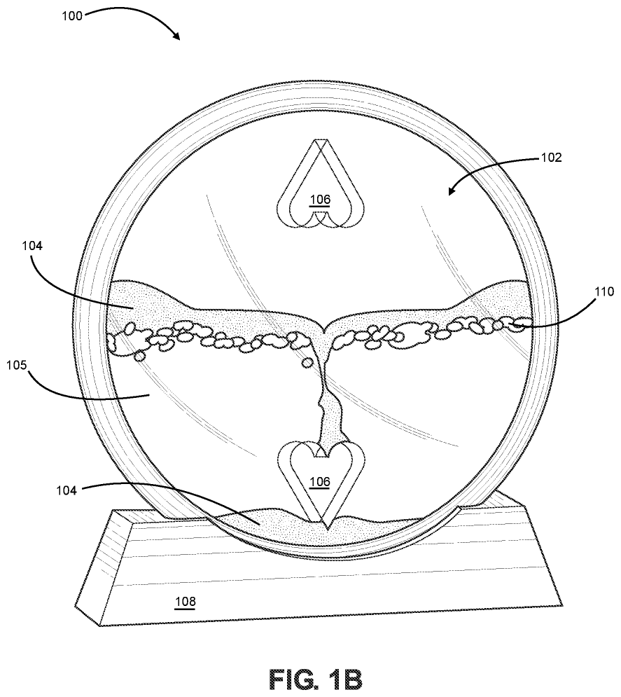

With reference to FIGS. 1A and 1B illustrate certain embodiments of a device configured to visually transform internal imagery as an hourglass or visual timer 100 comprising different flowable media within their hollow interiors. Such device will be referred to alternatively as a visual timer or hourglass throughout this detailed description for the sake of brevity, however, it will be understood that the device need not accurately or precisely keep time in order to practice the invention.

In general, the visual timer 100 comprises a housing 102 defining a hollow and watertight interior, some flowable media, such as flowable media 104, 105, contained within the hollow interior, one or more internal visual elements 106, here a plurality of hearts, disposed within and spanning the width of some portion of the hollow interior in order to maintain them in position within the hollow interior, and means for supporting the visual timer in a vertical position 108.

Materials comprising the housing 102, some of the flowable media, such as flowable medium 105, and one or more internal visual elements 106 may be selected so that they appear visually indistinct from one another, or, in other words, so that the one or more internal visual elements 106 are imperceptible or visually indistinct from the housing 102 and flowable medium 105 when surrounded only by such flowable media 105.

In an embodiment, the housing may comprise any at least partially light permeable, translucent, or transparent material as needed or desired. For example only and not limitation, the housing may comprise glass, plexiglass, acrylic, polymethyl methacrylate (PMMA) or another resin, polycarbonate, polylactic acid (PLA), epoxy, or any other at least partially transparent material or combination of at least partially transparent materials suitable to contain flowable media. In FIGS. 1A, 1B, 2 and 3, it may be seen that a frame 112 is provided, which may be configured to seal the housing 102.

In order to render the internal visual elements 106 visually indistinct from the housing 102, it is contemplated that any of such one or more internal visual elements 106 may also be transparent or translucent to varying degrees. In some embodiments, such internal visual elements may comprise, for example only and not limitation, glass, plexiglass, acrylic, epoxy, PMMA, PLA, or any transparent plastics, resins, glue or silicon, or combination of such materials, known to those of ordinary skill in the art. In some embodiments, the material comprising any of the at least one internal visual elements 106 may be the same as the material of the housing. In any event, it is contemplated that the one or more internal visual elements 106 may be visually indistinct or indistinguishable from the housing 102 when viewed from a distance, but appear to transform or materialize as visually distinct flowable media, such as flowable media 104, surrounds or otherwise moves about such one or more internal visual elements 106.

To that end, in some embodiments, at least some of the flowable media, the housing, and internal visual elements may be the same color and transparency as one another. In some embodiments, the housing and internal visual elements may even be the same material. Indeed, it is contemplated that any materials comprising the housing and internal visual element may be selected so as to reduce the refractive index of light transmitted through such flowable medium, the housing, and internal visual elements to prevent or at least reduce any visual distinction that may be otherwise caused by refraction.

In some embodiments, flowable media may comprise, for example only and not limitation, any combination of sand, other granules, gas, fluid, oil, water, and colored water. In one exemplary embodiment, the flowable medium comprises a fluid such as water and sand or some other granular material having a different specific gravity from the fluid, so that the sand or other granular material is able to fall in response to gravity within the fluid at a definite rate, dependent, as one of ordinary skill in the art will recognize, upon the density and viscosity of the fluid.

Likewise, it is contemplated that the flowable medium may comprise a plurality of visually distinct fluids, such as two fluids, three fluids, four fluids, or even more, each having a different specific gravity—or relative density—from one another so that each fluid is able to fall in response to gravity at a different definite rate, dependent upon the relative density and viscosity of each fluid in the housing.

In some embodiments, the fluids may be visually distinguished from one another by color. In some embodiments, the fluids, or, more specifically, any sand, other granules, gasses, fluids and the like comprising flowable media, may be visually distinguished from one another by relative opacity. The particular manner of visual distinction will not limit the invention.

In FIGS. 1A and 1B, exemplary flowable medium 104 may be, for example transparent, colorless water, while exemplary flowable medium 105 may be fine sand. In accordance with the foregoing then, when the visual timer 100 is vertically adjusted and flowable medium 104 shifts in response to gravity, the one or more internal visual elements 106, in some embodiments otherwise visually imperceptible or indistinguishable when surrounded by flowable medium 105, are apparently transformed or revealed when surrounded by flowable medium 104. With reference to FIG. 1B in particular, air bubbles 110 may be introduced in any manner known to those of skill in the art, such as by providing a soap water suspension as flowable medium 104, in order to decrease or otherwise influence the rate at which flowable medium 105 visually transforms the one or more internal visual elements 106. Of course, the one or more internal visual elements 106 have been visually distinguished from all other elements in the figures for the purposes of illustrating the visual timer configured to transform internal imagery. This is intended only for clarity and understanding and not to limit the invention.

Means for supporting the visual timer 100 in a user-selected vertical position may be integrated along an exterior defined by the housing or otherwise be provided as an element separable from the housing. In FIGS. 1A and 1B such means is provided as a stationary base 108 separable from the housing 102 but configured to vertically support the housing 102 in an adjustable, vertical position.

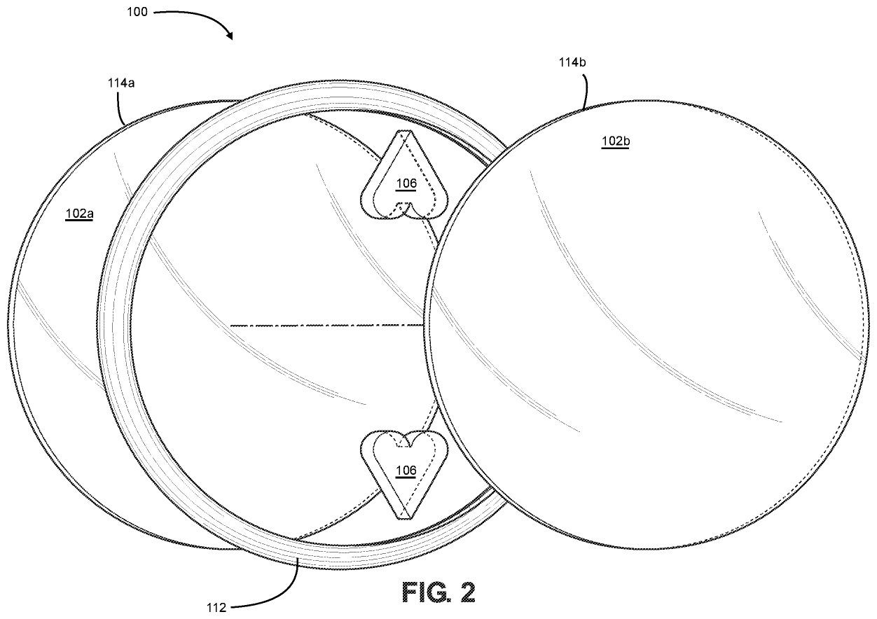

Turning to FIG. 2, an exploded view of the visual timer 100 is provided to exemplify one manner of its construction. In particular, housing may comprise a front and rear face 102a, 102b joined together and rendered watertight by a frame 112 or another sealing border. In some embodiments, faces 102a, 102b may bow outward from one another and sealed to one another along outer edges 114a, 114b in any manner known to one of ordinary skill in the art.

It is not necessary to form the housing as a circle. The housing may take any shape as needed or desired, which will be discussed further below.

The one or more internal visual elements 106 may be maintained in position within the hollow interior of the housing in any manner known to one of ordinary skill in the art as well. For instance, in some embodiments, the one or more internal visual elements 106 may be frictionally maintained between each face 102a, 102b. In some embodiments, the one or more internal visual elements 106 may be adhered or bonded to an interior surface of the housing with glue or the like. In some embodiments, the one or more visual elements 106 may be bodily integrated with at least a portion of an interior surface of the housing such as by molding, extrusion, three-dimensional printing, and the like. The particular manner of maintaining the one or more visual elements 106 within the hollow interior of the housing will not limit the invention.

It is also worth noting, and one of ordinary skill in the art will recognize, that the one or more internal visual elements 106, here represented by two exemplary hearts, may take any form or shape, be provided in any number or combination, and placed in any manner within the hollow interior of the housing as needed or desired without departing from the invention. That is, it is contemplated that the one or more internal visual elements may comprise letters, words, symbols, icons, logos, shapes, silhouettes, characters, animals, emojis, scenes, images, whether abstract or otherwise, in any combination and number and placed in any manner within the hollow interior of the housing.

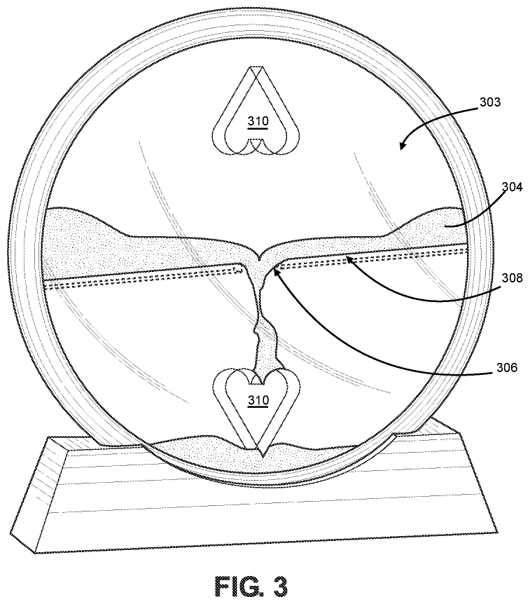

In the exemplary, nonlimiting embodiment shown in FIG. 3, the flowable media may comprise a colorless gas 302 and some granulated material 304 which passes through an opening 306 defined by a divider 308 within the hollow interior of the housing. Of course, the divider 308 may define any number of openings desired, and the divider 308 may be configured in any shape or position as needed or desired. That is, the divider 308 may be curved, bent, slanted, or shaped in any manner. A particular shape or configuration may be desired, for instance, to influence the flow of media within the hollow interior of the housing. As such, the divider 308 is depicted as flat line defining a single opening is provided for the sake of simplicity only and not limitation.

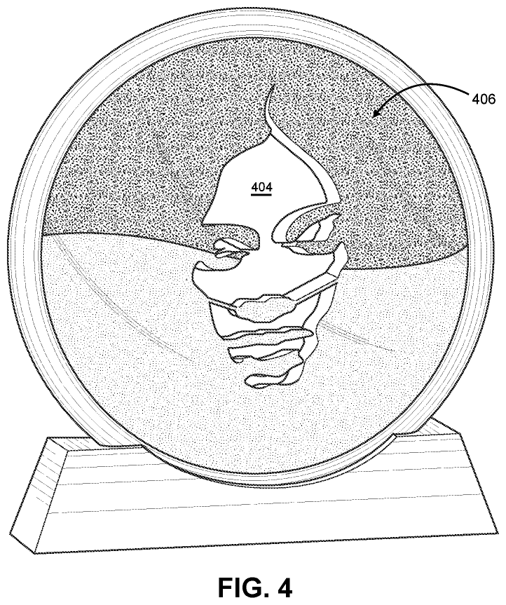

One each of the exemplary internal visual elements 310 are disposed on opposite sides of the divider 308. Likewise, in FIGS. 1A, 1B, and 2, exemplary internal visual elements 106 appear to be symmetrically disposed on opposite sides of an imaginary midline. However, it is contemplated that any internal visual elements may be disposed asymmetrically within the hollow interior, at or even crossing the midline, and in any other position within the hollow interior as needed or desired. Turning to FIG. 4 as one example, internal visual elements 404 are together provided to define a silhouette of a face. Notably, internal visual elements 404 here comprise an exemplary single, asymmetric image crossing an invisible midline defined by the housing 406.

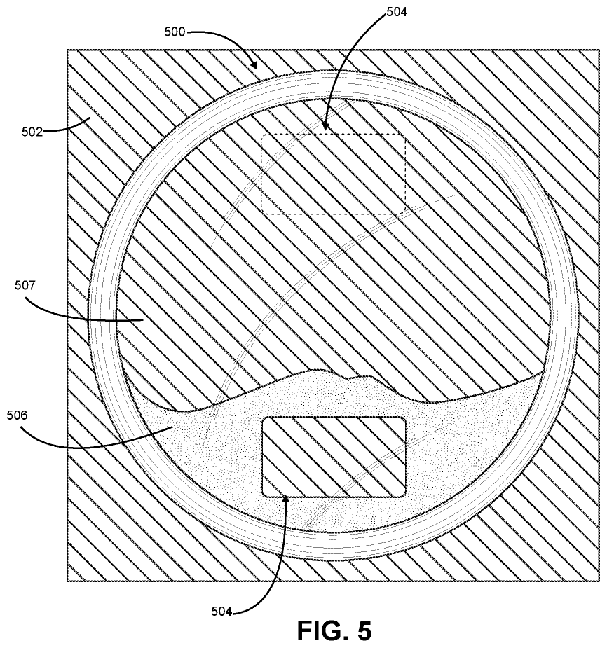

Other elements may be provided to visually transform the visual timer as well. For instance, FIG. 5 depicts a visually distinct placard 502, of any shape or material, in position behind the visual timer 500. This embodiment depicts generic internal visual elements 504 for the purpose of contextualizing the placard 502 only and not limiting the invention. Such placard 502 may be interchangeable with another to enable a user to personalize the appearance of the visual timer 500. Such placard(s) may comprise any visual imagery desired, such as landscapes, photos, paintings, drawings, logos, solid or abstract backgrounds, color filters, or any other designs desired. The vertical position of the visual timer 500 may be adjusted together with or independently from the placard 502. In any event, when the visual timer 500 is vertically adjusted, flowable media 506, 507 will move in response to gravity and transform the appearance of internal visual elements 504, such as by surrounding one of the internal visual elements 504 that was previously visibly indistinguishable from the housing and flowing medium 507. In some embodiments, placard 502 may beneficially visually obscure or distract from the presence of any visually indistinct internal visual elements so that the effect of transforming or revealing or altering such internal visual elements is enhanced.

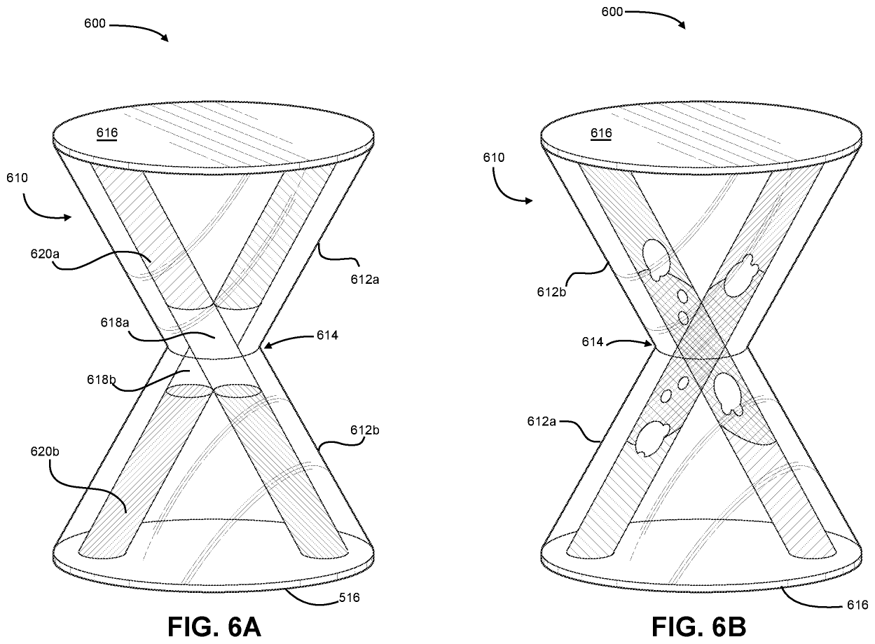

As previously noted, a housing comprising the visual timer or hourglass may define any shape as desired or needed, and therefore, the particular shape of the housing will not limit the invention. Thus, for instance, one embodiment of the visual timer is shown in FIGS. 6A and 6B in which the exemplary housing 610 is shaped similarly to a conventional hourglass having opposing conical sides 612a, 612b joined by a slender neck 614 configured to permit communication of the flowable medium between each side. Thus, it will be recognized that the housing may be cylindrical, spherical, polyhedral, ellipsoid, irregularly bulbous, or indeed any other shape or style. The housing need not, but may be, symmetrical on any axis to practice the invention.

It will also be recognized that means for supporting the visual timer 600 in an adjustable vertical position is inseparably integrated along a portion of the housing 610 in this exemplary embodiment as a flat base 616. As previously noted, however, the such means for supporting the visual timer may take any form suitable for supporting the visual timer in an adjustable vertical position, such as by a frame that is integrated with or connectable to the housing, one or more legs, a tripod, or other supportive mechanism as needed or desired.

In this case, the internal visual elements 618a, 618b comprise a plurality of tubes while the flowable media comprises multiple visually distinct liquids 620a, 620b. These may be different colors from each other, which are not be limited in any manner. In any event, when the visual timer 600 is vertically adjusted, the visually distinct liquids 620a, 620b having different specific gravity from one another, cross one another and visually transform the appearance of the internal visual elements 618a, 618b.

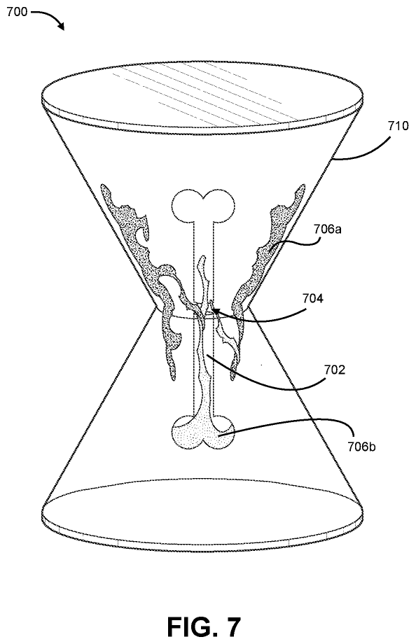

Similarly, FIG. 7 shows a visual timer 700 having an internal visual element 702 as a dog bone nested within the housing 710. In this case, the internal visual element 702 defines an opening 704 that permits the flowable media, also shown as a plurality of visually distinct liquids 706a, 706b, to communicate between the interior of the housing 710 and internal visual element 702. The size and position of any opening, such as opening 704, in the internal visual element 702, and indeed the particular size and shape of the internal visual element 702, including any portion of the internal visual element 702 that connects the internal visual element 702 to an interior surface of the housing, may be selected to enable or even optimize communication of the flowable media within the housing 710, and, as the case may be, between the hollow interior of the housing 710 and internal visual element 702. That is, opening 704 may be shaped, sized, or positioned to direct flowable media in a desired manner. This may depend on the particular fluid properties of flowable media comprising the visual timer 700.

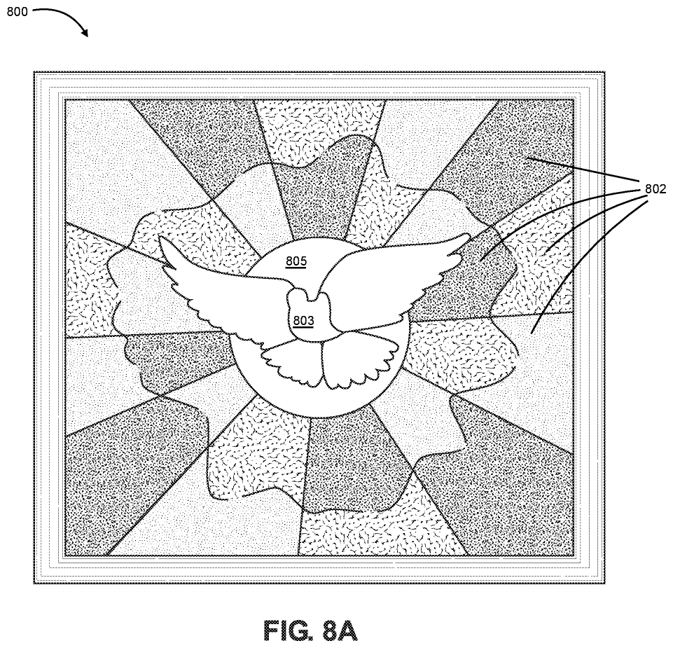

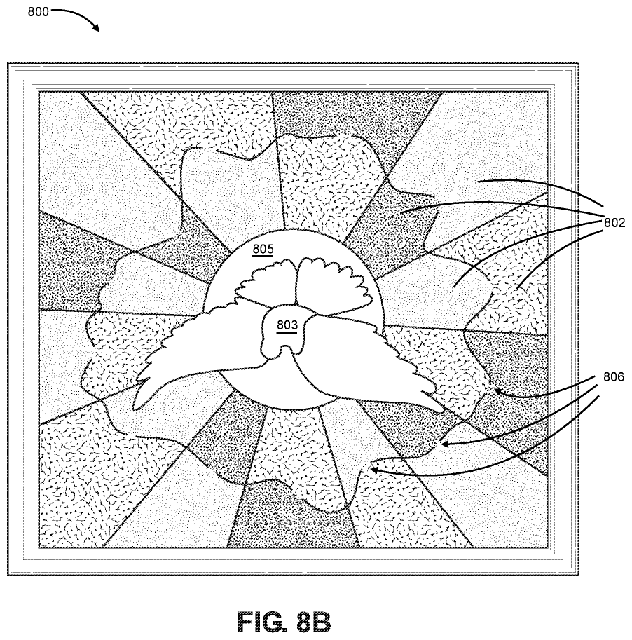

FIGS. 8A and 8B illustrate another exemplary embodiment of the visual timer 800 which comprises an internal visual element defined by a series of segmented chambers 802 that together form a picture. In the exemplary embodiment, the picture is of a bird in flight 803 in the rays of the sun 805. When vertically adjusted, as in FIG. 8B, the visually distinct flowable media (depicted by various levels and types of stippling) shifts in response to gravity and enters other chambers as enabled by openings 806 between each chamber, transforming the appearance of the internal visual element. It may be appreciated that this exemplary embodiment of the visual timer 800 is rectangular in a planar view.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

### Conclusions, Ramifications, and Scope

While certain embodiments of the invention have been illustrated and described, various modifications are contemplated and can be made without departing from the spirit and scope of the invention. Accordingly, it is intended that the invention not be limited, except as by the appended claim(s).

The teachings disclosed herein may be applied to other systems, and may not necessarily be limited to any described herein. The elements and acts of the various embodiments described above can be combined to provide further embodiments. All of the above patents and applications and other references, including any that may be listed in accompanying filing papers, are incorporated herein by reference. Aspects of the invention can be modified, if necessary, to employ the systems, functions and concepts of the various references described above to provide yet further embodiments of the invention.

Particular terminology used when describing certain features or aspects of the invention should not be taken to imply that the terminology is being refined herein to be restricted to any specific characteristics, features, or aspects of the visual timer configured to transform internal imagery with which that terminology is associated. In general, the terms used in the following claims should not be constructed to limit the visual timer configured to transform internal imagery to the specific embodiments disclosed in the specification unless the above description section explicitly define such terms. Accordingly, the actual scope encompasses not only the disclosed embodiments, but also all equivalent ways of practicing or implementing the disclosed system, method and apparatus. The above description of embodiments of the visual timer configured to transform internal imagery is not intended to be exhaustive or limited to the precise form disclosed above or to a particular field of usage.

While specific embodiments of, and examples for, the method, system, and apparatus are described above for illustrative purposes, various equivalent modifications are possible for which those skilled in the relevant art will recognize.

While certain aspects of the method and system disclosed are presented below in particular claim forms, various aspects of the method, system, and apparatus are contemplated in any number of claim forms. Thus, the inventor reserves the right to add additional claims after filing the application to pursue such additional claim forms for other aspects of the visual timer configured to transform internal imagery.

What is claimed is:

1. A device configured to visually transform internal imagery by cascade of flowable media, comprising:
an at least partially light permeable, translucent, or transparent housing defining a hollow and watertight interior;
a plurality of flowable media contained within said hollow interior;
one or more at least partially light permeable, translucent, or transparent internal visual elements disposed within and spanning the width of some portion of said hollow interior; and
means for supporting the visual timer in an adjustable vertical position;
wherein the one or more internal visual elements are configured to visually transform as said the flowable media moves about such one or more internal visual elements in response to gravity upon adjustment of the vertical position of the housing.

2. The device of claim 1, wherein the one or more internal visual elements are visually indistinct from at least one of the flowable media or otherwise imperceptible within the housing when viewed from a distance but appear to transform or materialize as another of said flowable media surrounds or moves about such one or more internal visual elements.

3. The device of claim 1, wherein the housing comprises material selected from the group consisting of glass, plexiglass, acrylic, polymethyl methacrylate (PMMA), polycarbonate, polylactic acid (PLA), and epoxy, or any combination thereof.

4. The device of claim 1, wherein means for supporting the visual timer in a vertical position is separable from said housing.

5. The device of claim 1, wherein the means for supporting the visual timer in a vertical position is integrated along a portion of an exterior surface defined by the housing.

6. The device of claim 1, wherein the one or more internal visual elements comprise a material selected from the group consisting of glass, plexiglass, acrylic, epoxy, PMMA, PLA, transparent plastics, transparent resins, glue, silicon, or any combination thereof.

7. The device of claim 1, wherein the one or more internal visual elements comprise the same material as the housing.

8. The device of claim 1, wherein the materials comprising the housing and at least internal visual element are selected to minimize the refractive index of light transmitted through such housing and one or more internal visual elements.

9. The device of claim 1, wherein the flowable media comprises a plurality of visually distinct fluids, each having a different specific gravity from one another.

10. The device of claim 9, wherein the visually distinct fluids are distinguished by color.

11. The device of claim 9, wherein the visually distinct fluids are distinguished by relative opacity.

12. The device of claim 1, wherein the one or more internal visual elements comprise letters, words, symbols, icons, logos, shapes, silhouettes, characters, animals, emojis, scenes, images, or any combination thereof, placed in any number or manner within the hollow interior of the housing.

13. An hourglass assembly, comprising:
an at least partially light permeable, translucent, or transparent translucent housing defining a hollow and watertight interior;
a plurality of flowable media contained within said hollow interior;
one or more at least partially transparent or translucent internal visual elements maintained within said hollow interior and visually indistinct from the translucent housing and at least one of the plurality of flowable media; and
means for supporting the visual timer in an adjustable vertical position;
wherein the one or more internal visual elements are configured to visually transform as at least one other of the plurality of flowable media moves about such one or more internal visual elements in response to gravity upon adjustment of the vertical position of the housing.

14. The hourglass assembly of claim 13, wherein the housing comprises material selected from the group consisting of glass, plexiglass, acrylic, polymethyl methacrylate (PMMA), polycarbonate, polylactic acid (PLA), and epoxy, or any combination thereof.

15. The hourglass assembly of claim 13, wherein the one or more internal visual elements comprise a material selected from the group consisting of glass, plexiglass, acrylic, epoxy, PMMA, PLA, transparent plastics, transparent resins, glue, silicon, or any combination thereof.

16. The hourglass assembly of claim 13, wherein the one or more internal visual elements comprise letters, words, symbols, icons, logos, shapes, silhouettes, characters, animals, emojis, scenes, images, or any combination thereof, placed in any number or manner within the hollow interior of the housing.
